(19) United States
(12) Patent Application Publication
(10) Pub. No.: US 2008/0116701 A1
(43) Pub. Date: May 22, 2008

(54) Metal And Plastic Composite Structure In Particular For The Front Face Of A Motor Vehicle

(76) Inventors: Francois Boumaza, Paris (FR); Jean-Louis Lanard, Feucherolles (FR); Jean-Nicolas Guyomard, Le Mesnil Fuguet (FR)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/588,119

(22) PCT Filed: Feb. 17, 2005
(86) PCT No.: PCT/FR05/00375

§ 371 Date: Sep. 26, 2007

(30) Foreign Application Priority Data
Feb. 17, 2004 (FR) 0401565

(51) Int. Cl. B62D 29/00

(52) U.S. Cl. 293/120

(57) ABSTRACT

The composite structure of the invention comprises a metal insert (10) having a shaped core (12) of chosen profile, possessing two opposed marginal regions (18), and a plastic reinforcement (28) overmolded on at least part of the insert. The core (12) of the insert includes at least one deep-drawn portion (24) which extends in a generally transverse direction with respect to at least one of the marginal regions (18) of the core, whereas the reinforcement (28) includes at least one reinforcing element (32) which covers the deep-drawn portion (24) and which connects two end regions (30) of the reinforcement (28) covering the two marginal regions (18) of the core, respectively. Application particularly to motor vehicle front faces.

The invention relates to a metal and plastic composite structure which can be used particularly for the manufacture of motor vehicle components.

Composite structures of this kind, sometimes also referred to as “hybrid structures”, are already known and they comprise a metal insert having a shaped core of chosen profile possessing two opposed marginal regions, and a plastic reinforcement overmolded on at least part of the insert.

Such composite structures find a particular application in the production of motor vehicle front faces, be these made in one or more parts.

A front face constitutes a subassembly, which may be produced by an equipment manufacturer, and the automobile manufacturer is required only to position it at the front of the vehicle and to fasten it to structural elements of the vehicle.

This front face serves to support various components such as, for example, lighting units, heat exchangers, horns, hood locks, etc.

One of the problems posed by the production of composite structures of the aforementioned type is that of attaching the plastic reinforcement to the metal insert, given that this reinforcement is conventionally overmolded on at least part of the insert.

One solution known from EP patent 1 213 207 is to produce the mechanical connection by wrapping the plastic reinforcement around the metal insert. This wrapping is produced during the plastic injection molding. To produce this wrapping, it is necessary to overmold strips of plastic over the insert, which complicates manufacture.

Moreover, holes are usually provided in the metal sheet of the insert to facilitate attachment of the plastic.

These holes therefore require specific machining operations and additionally have a tendency to weaken the composite structure thus obtained.

This disadvantage is also encountered in the structure described in document DE 203 10 656, in which holes or the like are formed in the sheet of the metal insert to facilitate attachment of the plastic.

There are also other solutions, such as that disclosed in document WO 02/068258, for example, which requires overmolding virtually the entirety of the insert to permit attachment of the plastic.

These known solutions therefore require a large amount of plastic with respect to the insert.

The object of the invention is in particular to overcome the aforementioned disadvantages.

The invention aims in particular to provide a composite structure of the aforementioned type in which the attachment between the metal and the plastic is brought about by means which bear a similarity to wrapping, but without piercing the sheet of the insert.

The invention additionally aims to provide a hybrid structure of the aforementioned type which finds a specific application in the production of motor vehicle front faces.

To this end, the invention proposes a composite structure of the type defined in the introduction, in which the core of the insert includes at least one deep-drawn portion which extends in a generally transverse direction with respect to at least one of the marginal regions of the core, and in which the reinforcement includes at least one reinforcing element which covers the deep-drawn portion of the insert and which connects two end regions covering the two marginal regions of the core, respectively.

Thus, the attachment is brought about by cooperation between a deep-drawn portion formed in the insert and a reinforcing element which forms part of the reinforcement and which comes to cover this deep-drawn portion so as to produce mechanical attachment and locking.

The deep-drawn portion is preferably produced in the form of a groove, that is to say a recessed relief, and the reinforcing element in the form of a rib which is accommodated in the groove.

It should be pointed out that the production of a groove in an insert of this type, which is a metal sheet, also forms a rib on an opposed face of the sheet. In other words, the deep-drawn portion forms a groove on one side and a rib on the other.

When the deep-drawn portion is a rib, the reinforcing element is advantageously produced in the form of a rib which covers the rib.

As indicated already, the deep-drawn portion usually forms, on the one hand, a groove which emerges on one face of the core of the insert and, on the other hand, a rib which emerges on another face of the core of the insert.

It is advantageous in this case that the reinforcing portion forms, on one side, a first rib which covers the groove of the insert and, on the other side, a second rib which covers the rib of the insert.

Advantageously, the core of the insert has an open profile, for example a U-shaped profile, with an internal face and an external face. In this case, the deep-drawn portion may be formed either on the internal face of the core or on the external face of the core, or else on both the internal face and the external face.

To facilitate attachment, it is advantageous that at least one of the end regions of the reinforcement is arranged in the form of a lip which covers a marginal region of the core.

To further improve the mechanical attachment, it is advantageous that at least one of the end regions of the reinforcement is arranged in the form of a notched edge.

Furthermore, at least one of these end regions may be arranged in the form of a raised edge.

Preferably, the deep-drawn portion of the insert extends from one of the marginal regions of the core to the other. However, it is also conceivable for this deep-drawn portion to extend only over part of the core between the marginal regions of the core.

The composite structure of the invention advantageously forms an integral part of at least one element of a motor vehicle front face.

In the description which follows, given purely by way of example, reference will be made to the appended drawings, in which:

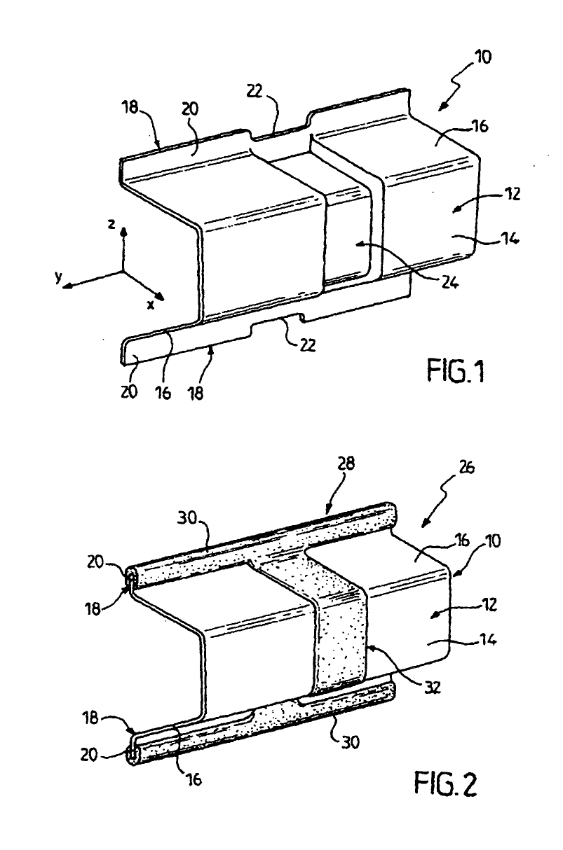

FIG. 1 is a perspective view of a metal insert of U-shaped general profile according to the invention;

FIG. 2 represents the insert of FIG. 1 on which a plastic reinforcement has been overmolded to form a composite structure according to the invention;

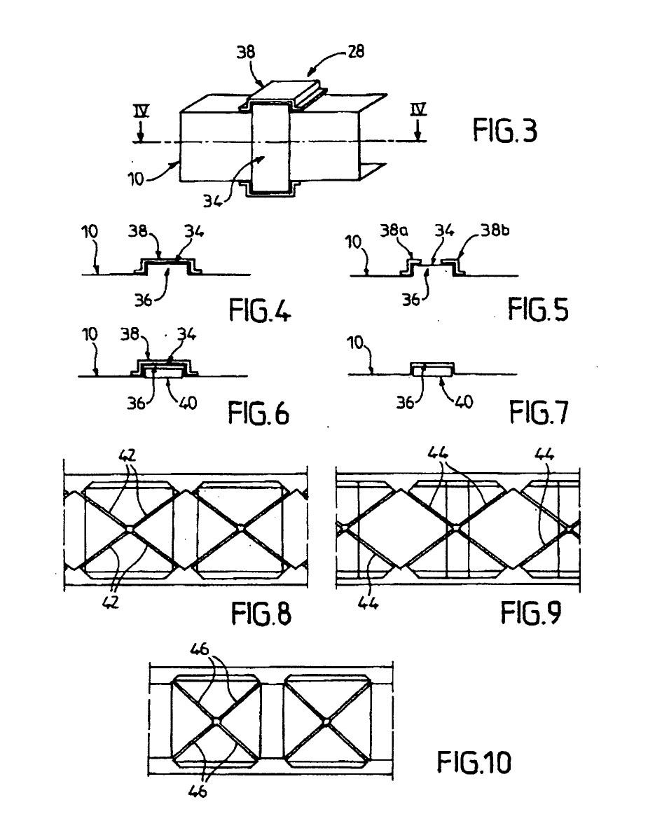

FIG. 3 represents a perspective view of a composite structure according to the invention comprising an outwardly projecting deep-drawn portion;

FIG. 4 is a view in section taken along line IV-IV of FIG. 3;

FIG. 5 is an analogous view to FIG. 4 in a variant embodiment;

FIGS. 6 and 7 are other sectional views illustrating two other variants;

FIGS. 8 to 10 are plan views of a composite structure according to the invention comprising an insert with a U-shaped profile and a plastic reinforcement comprising reinforcing ribs, forming crosspieces, in different variants;

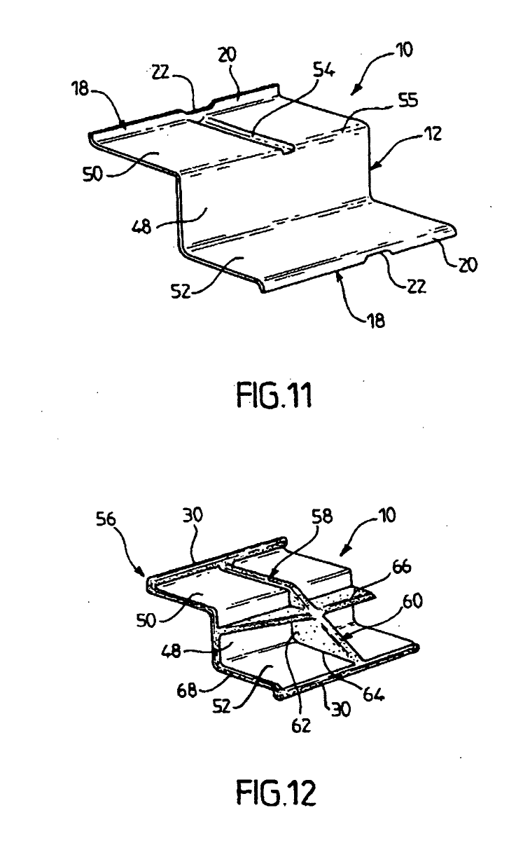

FIG. 11 is a perspective view of another insert according to the invention whose core comprises a stepped profile of the stair type with a deep-drawn portion; and

FIG. 12 represents the insert of FIG. 11 on which a plastic reinforcement is overmolded to form a composite structure according to the invention.

Reference will first be made to FIG. 1, which represents an insert 10 according to the invention comprising a core 12 formed by a folded metal sheet so as to define a generally U-shaped profile. The profile is defined by generatrices which are parallel to an axis Y of a trirectangular system containing three axes X, Y and Z. The core 12 comprises a generally flat web 14 adjoined by two flanges 16, each of which is terminated by opposed marginal regions 18 each produced in the form of a turned-over edge 20. These two turned-over edges 20 are substantially coplanar and parallel to the plane of the web 14, and extend toward the outside of the U-shaped profile, as defined by the web 20 and the two flanges 16. In addition, each of the turned-over edges 20 has a notch 22 so as to define a notched edge.

The core 12 additionally comprises a deep-drawn portion 24 which extends in a generally transverse direction with respect to the marginal regions 18. This deep-drawn portion 24 has a generally U-shaped form and forms, on the one hand, a groove which emerges toward the outside of the U-shaped profile and, on the other hand, a rib (not visible in FIG. 1) which emerges toward the inside of the U-shaped profile. In the example, this deep-drawn portion 24 extends from one of the marginal regions 18 to the other and thus forms a continuous relief in the web 14 and the two flanges 16.

Reference will now be made to FIG. 2, which represents a composite structure 26 resulting from overmolding a plastic reinforcement 28 on the insert 10 of FIG. 1. The reinforcement 28 comprises two end regions 30, each produced in the form of a U-shaped lip, covering a turned-over edge 20 and thus cooperating with the notches 22. These two end regions 30 thus constitute two longitudinal elements of U-shaped profile which extend along the marginal regions 18 of the insert 10.

The two end regions 30 are formed in one piece with a reinforcing element 32 which comes to cover the deep-drawn portion 24 of the insert. This element 32 is overmolded in the deep-drawn portion 24 on the outer side of the U-shaped profiled member, that is to say in the groove formed by this deep-drawn portion. In other words, the reinforcing element 32 constitutes a rib which is engaged in the groove formed by the deep-drawn portion 24. There is thus formed a partial wrap which provides the connection between the end regions 30 of the reinforcement 28 and prevents any translational movement of the reinforcement in a generally parallel direction to the generatrices defined by the U-shaped profile of the insert, that is to say in the direction of the Y axis.

This solution offers the advantage of producing good mechanical attachment without it being necessary to make holes in the thickness of the insert.

FIG. 3 shows an insert 10, analogous to that of FIG. 1, which likewise has a U-shaped profile. However, unlike FIG. 1, this insert 10 here comprises a deep-drawn portion 34 which defines a U-shaped rib projecting toward the outside of the profile. That means that this deep-drawn portion 34 defines, by contrast, a groove 36 toward the inside of the U-shaped profile, as shown in FIG. 4.

The reinforcement 28 comprises a reinforcing element 38 in the form of a rib 38 which externally covers the rib 34. In the case of FIG. 4, the reinforcing portion 38 completely covers the rib 34.

In the variant of FIG. 5, this rib 38 is composed of two spaced apart portions 38a and 38b which each partially cover the rib 34.

In the embodiment of FIG. 6, the deep-drawn portion of FIG. 3 reappears, defining a rib 34 on one side and a groove 36 on the other.

In this case, the reinforcing element comprises both a reinforcing element 38 which covers the rib 34 and a reinforcing element 40 which covers the rib 36. In other words, the reinforcing element is situated on two faces of the profile.

In the embodiment of FIG. 7, there is only one reinforcing element 40 inside the groove 36.

Thus, the reinforcing element forms, on one side, a first rib 40 which covers the groove 36 and, on the other side, a second rib 38 which covers the rib 34. Thus, the deep-drawn portion can be formed equally well either on the internal face of the core, that is to say in this case on the inside of the U-shaped profile, or on the external face of the core, that is to say on the outside of the U-shaped profile.

In the case of a U-shaped profile, it may be advantageous to overmold the plastic on the inside of the profile as well, as shown in FIGS. 8, 9 and 10, and to provide additional reinforcing ribs in the form of crosspieces. FIGS. 8, 9 and 10 show three types of different crosspieces, respectively 42, 44 and 46.

Reference will now be made to FIG. 11, which shows another insert 10 according to the invention, the core 12 of which here has a stepped or stair-like shape. It comprises a generally flat web 48 adjoined at a right angle by two likewise generally planar flanges 50 and 52, which respectively extend on two opposed sides with respect to the web 48. These two flanges 50 and 52 have marginal regions 18 which are analogous to those described above, each forming a raised edge 20 provided with a notch 22.

The insert 10 comprises a deep-drawn portion 54 which, in the example, is formed solely in the flange 50. This deep-drawn portion forms an outwardly directed groove or channel extending from the marginal region 18 as far as a fold line 55 which connects the flange 50 to the web 48. The groove-forming deep-drawn portion 50 extends in a generally transverse, in this case perpendicular, direction to the marginal region 18 of the flange 50.

FIG. 12 shows the hybrid structure obtained after overmolding a reinforcement 56 on the insert 10 of FIG. 11. This reinforcement 56 has two end regions 30, in the form of lips of U-shaped profile, which cover the marginal regions 18 of the insert. These two end regions 30 are interlinked by a rib-shaped reinforcing element 58 which is overmolded in the groove-shaped deep-drawn portion 54 formed in the flange 50. The portion 58 starts from one of the end regions 30, runs transversely along the flange 50 and is extended by a reinforcement 60 of triangular structure having two edges 62 and 64 which are applied against the web 48 and the flange 52, respectively. This reinforcement 60 terminates at the other end region 30.

Thus, the edges 62 and 64 are applied to planar faces of the insert and do not come to cooperate with a deep-drawn portion, unlike the reinforcing element 58. Connected to the element 60 is another reinforcing element 66 forming a continuous rib which extends along the web 48 in a generally parallel direction to the end regions 30, that is to say in the direction of the Y axis.

This element 66 terminates at an overmolded element 68 of stair-like profile which covers the edge of the insert and which extends between the two end regions 30.

It will be understood that many variant embodiments can be applied to the composite structure of the invention, on the one hand with regard to the structure of the insert and, on the other hand, with regard to the structure of the plastic reinforcement.

As a general rule, the insert may have a chosen profile which is most often, but not necessarily, of generally U-shaped form.

The deep-drawn portion formed in the insert may extend over part or over the whole of the insert between two marginal regions thereof. This deep-drawn portion may extend over only part of the insert, as in the case of FIGS. 11 and 12.

Likewise, many variants can be applied to the shape of this deep-drawn portion. It may be produced in the form of a groove or of a rib or both at the same time. In each case the reinforcing element of the reinforcement will cooperate with this deep-drawn portion by covering it so as to ensure locking through shape cooperation.

Most often, the insert will be produced in the form of a metal sheet and the reinforcing element will be made of a thermoplastic, in particular polyamide.

The invention applies very particularly to the production of motor vehicle front faces.

1. A composite structure comprising a metal insert (10) having a shaped core (12) of chosen profile, possessing two opposed marginal regions (18), and also a plastic reinforcement (28; 56) overmolded on at least part of the insert (10), characterized in that the core (12) of the insert (10) includes at least one deep-drawn portion (24; 34; 54) which extends in a generally transverse direction with respect to at least one of the marginal regions (18) of the core, and in that the reinforcement (28; 56) includes at least one reinforcing element (32; 38; 40; 58) which covers the deep-drawn portion (24; 34; 54) of the insert and which connects two end regions (30) of the reinforcement (28) covering the two marginal regions (18) of the core (12), respectively.

2. The composite structure as claimed in claim 1, characterized in that the deep-drawn portion is a groove (24), and in that the reinforcing element is a rib (32) which is accommodated in the groove (24).

3. The composite structure as claimed in claim 1, characterized in that the deep-drawn portion is a rib (34) and in that the reinforcing element is a rib (38) which covers the rib (34).

4. The composite structure as claimed in claim 1, characterized in that the deep-drawn portion forms, on the one hand, a groove (36) which emerges on one face of the core (12) and, on the other hand, a rib (34) which emerges on another face of the core, and in that the reinforcing element forms, on one side, a first rib (40) which covers the groove (36) of the insert and, on the other side, a second rib (38) which covers the rib (34) of the insert.

5. The composite structure as claimed in one of claims 1 to 4, characterized in that the core (12) of the insert (10) has an open profile, in particular a U-shaped profile, with an internal face and an external face and in that the deep-drawn portion (24; 34; 54) is formed on the internal face of the core.

6. The composite structure as claimed in one of claims 1 to 4, characterized in that the core (12) of the insert (10) has an open profile, in particular a U-shaped profile, with an internal face and an external face, and in that the deep-drawn portion (24; 34; 54) is formed on the external face of the core.

7. The composite structure as claimed in one of claims 1 to 6, characterized in that at least one of the end regions (30) of the reinforcement is arranged in the form of a lip which covers a marginal region (18) of the core (12).

8. The composite structure as claimed in one of claims 1 to 7, characterized in that at least one of the end regions (30) of the reinforcement (28) is arranged in the form of a notched edge (20, 22).

9. The composite structure as claimed in one of claims 1 to 8, characterized in that at least one of the end regions (30) of the reinforcement is arranged in the form of a raised edge (20).

10. The composite structure as claimed in one of claims 1 to 9, characterized in that the deep-drawn portion (24) of the insert (10) extends from one of the marginal regions (18) of the core (12) to the other.

11. The composite structure as claimed in one of claims 1 to 9, characterized in that the deep-drawn portion (54) extends over part of the core (12) between the marginal regions (18) of the core.

12. The composite structure as claimed in one of claims 1 to 11, characterized in that it forms an integral part of at least one element of a motor vehicle front face.
